(19) United States
(12) Patent Application Publication
(10) Pub. No.: US 2014/0107914 A1
(43) Pub. Date: Apr. 17, 2014

(54) SYSTEMS, METHODS, AND SOFTWARE FOR UTILITY LOCATE, MAPPING, AND USAGE

(71) Applicants: James Toole, Centennial, CO (US); James Dougherty, Elizabeth, CO (US)

(72) Inventors: James Toole, Centennial, CO (US); James Dougherty, Elizabeth, CO (US)

(21) Appl. No.: 14/052,963

(22) Filed: Oct. 14, 2013

Related U.S. Application Data
(60) Provisional application No. 61/714,414, filed on Oct. 16, 2012.

(51) Int. Cl. G06F 7/00

(52) U.S. Cl. CPC G06F 7/00
USPC 701/300

(57) ABSTRACT

Systems, methods, and software for determining proximity to a utility and using the location information of the utility are provided herein. In one example, a non-transitory computer readable medium having stored thereon program instructions executable by a computing device is presented. When executed by the computing device, the program instructions direct the computing device to receive an indication of location of a utility, receive location information of a device, determine utility proximity information, and provide an indication of utility proximity information. The utility location information may then be used with map and other information, or used to control grading operations.

### CROSS REFERENCE TO RELATED APPLICATIONS

This application claims priority to, and benefit from, provisional patent application Ser. No. 61/714,414, entitled “SYSTEMS, METHODS, AND SOFTWARE FOR UTILITY LOCATE AND MAPPING”, filed Oct. 16, 2012, which is incorporated by reference for all purposes.

### TECHNICAL FIELD

Aspects of the disclosure are related to the field of utility indication, and in particular, to software, systems, and methods for indicating utilities' location and mapping using global positioning and use in applications at a later time.

### TECHNICAL BACKGROUND

Almost every time any excavation is done, local utility companies are contacted to come to the excavation site and indicate where the various utilities are buried so that the excavation does not damage one of the utilities. The indication of location typically is paint marks on the ground. Problems may arise if the excavation work is not complete promptly. The paint marks may be obscured or eliminated by weather or other construction going on in the area.

### OVERVIEW

Systems, methods, and software for determining proximity to a utility and using the location information of the utility are provided herein. In one example, a non-transitory computer readable medium having stored thereon program instructions executable by a computing device is presented. When executed by the computing device, the program instructions direct the computing device to receive an indication of location of a utility, receive location information of a device, determine utility proximity information, and provide an indication of utility proximity information. The utility location information may then be used with map and other information, or used to control grading operations.

In an embodiment a device is disclosed which comprises a user interface capable of receiving an indication of location of a utility, and a processor configured receive location information of the device, and provide an indication of proximity of the utility based at least in part on the indication of the location of the utility, and/or the location information of the device.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a utility indication and use system.

FIG. 2 is a flow diagram illustrating a method of operation of a utility indication system.

FIG. 3 is a system diagram illustrating a utility indication environment.

FIG. 4 is flow diagram illustrating a method of operation of a utility indication system.

### DETAILED DESCRIPTION

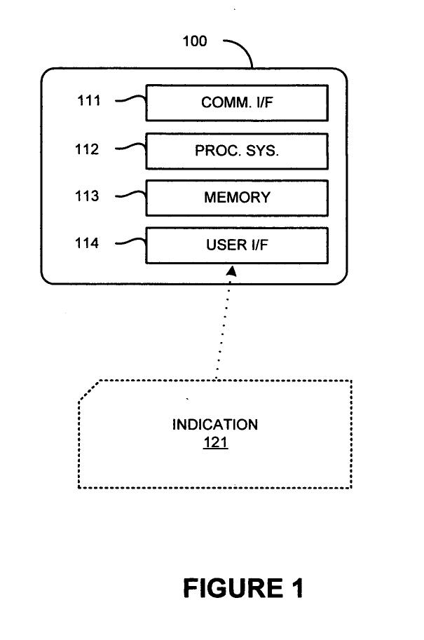

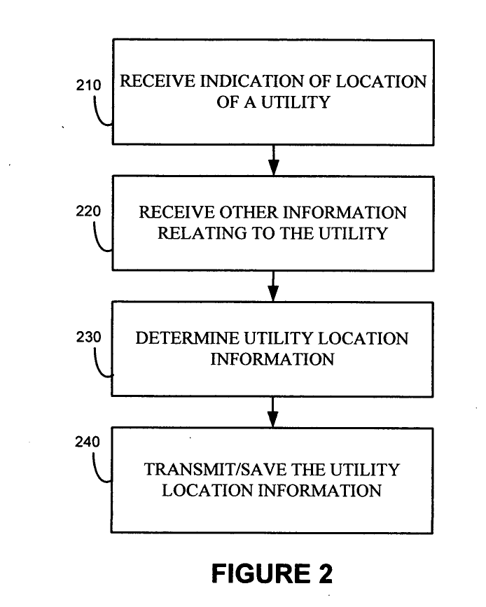

FIG. 1 is a system diagram illustrating utility indication system 100. Utility indication system 100 includes communication interface 111, processing system 112, memory 113, and user interface 114. In this example, user interface 114 receives an input for utility indication 121. In operation, processing system 112 is operatively linked to communication interface 111, memory 113, and user interface 114. Processing system 112 is capable of executing software stored in memory 113. When executing the software, processing system 112 drives utility indication system 100 to operate as described herein. In an embodiment, system 100 may be a personal communication device, such as a smartphone, with applications for operating as described with respect to FIGS. 2 and 4.

FIG. 2 is a flow diagram illustrating a method 200 of operation utility indication system 100, according to an example. The operations of FIG. 2 are referenced herein parenthetically. In FIG. 2, utility indication system 100 receives (210) an indication 121 of location of a utility. The indication may come from a utility locator operated by an employee of the utility company (or an independent company contracted to locate for the utility company) which owns a buried utility. Typically a utility locator comes to the excavation site and marks, with paint or other indicator, where the utility is located, and about how deep the utility is located, using some type of underground utility locator. The worker may also provide an input to the utility indication system. The utility indication system may use global positioning system (GPS) coordinates to indicate where the utility is located.

The indication of location of the utility 121 may also come from a directional bore machine, a robot used to traverse a pipe, a camera used to view the interior of the pipe, etc. The indication may also come when new utilities are installed.

Once utility indication system 100 receives 210 an indication of the location of the utility, system 100 may then receive 220 GPS or other information location of the utility when the utility employee provided the indication 210 to the system 100. The location information may be offset by the depth below grade the utility is estimated at, as well as the height the system is from grade when the indication is received. This may provide more accurate location information for the utility.

System 100 may incorporate the paint actuator along with the indication, or the system may be separate from the paint indication system the utility worker uses. The GPS system may include L1, L2, and/or L5-type GPS, and/or combinations thereof. It will be appreciated that the other information may be from another positioning or locating system, or any other system.

System 100 may then use the indication and the other locations information to determine 230 more accurate location information of the utility. In an example, a utility worker would press a button or some other indicator when a utility is detected. The button may be the same button the utility worker presses to distribute paint. The button press would cause GPS coordinates to be determined for the position of the device when the button is pressed, and/or a depth of the utility.

System 100 may then save/transmit the location information 230. The information may be saved on a local memory device, such as a hard drive, solid state drive, SD card, memory stick, or any other method or system for saving the information.

The location information may then be transmitted 240 or transferred. The location information may then be transmitted/transferred to the person(s) needing the information for construction or anyone else who might want the information. The utility location information may be used by the owner of the excavation site for future use. The further use may be with programs such as computer aided design programs. Furthermore the information may be used with auto-controlled grading equipment so that the grading operations may not unintentionally sever the utility. These grading applications may include those made or sold by Spectra Physics, Agtec, etc. In addition, the utility location information may be used by mapping companies, such as Google™ or other companies.

The utility location information may be uploaded to a central database, which may be updated every time a utility is located with a system 100, or whenever any other information from any source is received. The information may then become more and more accurate as more utility location information is uploaded and added to the database. The utility location information may be used with maps to add clarity to the utility location information. The utility location information may then be transmitted to a user at a later time to relocate previously located utilities.

A device and/or software may be used to locate the utility, typically by an employee of the utility owning the underground utility. The information may then be used with electronic map to create utility location information. The combining of information can be by the device the utility worker or a remote computer system. The coordinates of the utility may also be saved and used by itself. Then the utility location information can be stored in a database. The coordinates and/or the combined information may be sent to a device 100, such as a smartphone, to be used to relocate the utility. The smartphone will have software and the ability to use the coordinate and/or the combined information to relocate the utility using location of the device and the utility.

There may be an application (app) on the device used to locate the utility, programming to save the coordinates, and combine with a map, and an app to receive the information and use a GPS to relocate the utility.

On large construction sites where a lot of excavation/grading/construction needs to take place, this information may be given to all companies working on the site. The information may be accessible by a handheld device such as a smartphone or other handheld device. The smartphone may include an application to overlay the utility location information on a map. This may be accomplished at least in part using the GPS of the smartphone.

This may make the construction site relatively safer, and save money by not damaging the located utility. Furthermore, with GPS location information the utility employee may not have to return to the site to remark the utility if the paint indications get obscured, thereby saving money and time. The utility employee will likely need to come out at least once, even if the utility has previously been located, for safety and other reasons. The construction workers may use the information to remark the utilities.

The information may be used by designers to overlay on the design of the site to make plans and drawings more accurate, and to include the utility information. The information may be used on equipment such as backhoes, etc. that are equipped with on-board computer systems, to warn the operator they are getting close to the located utility. The information may be user to control grading/construction equipment to reduce the likelihood of unintentionally severing the utility.

The information may be used by the site owner, such as refineries or other industrial land owners, as information about the site that could be required for any personnel or construction company working on the site. The information may also be used by the utility company so they know where the utility lines are. The information may be used by locate services to help them locate utilities. The information may be used by cities, states, municipalities, and the government so they know where utilities are located. The information may be used by homeowners, to help them locate utilities on their property.

Referring back to FIG. 1, communication interface 111 may include communication connections and equipment that allows for communication with external systems and devices. Examples of communication interface 111 include network interface cards, wired interfaces, wireless interfaces, transceivers, antennas, power amplifiers, RF circuitry, optical networking equipment, and other communication circuitry.

Processing system 112 may be implemented within a single processing device but may also be distributed across multiple processing devices or sub-systems that cooperate in executing program instructions. Examples of processing system 112 include general purpose central processing units, microprocessors, application specific processors, industrial control devices, and/or logic devices, as well as any other type of processing device.

Memory 113 may comprise any storage media readable by processing system 112 and capable of storing software. Memory 113 may include volatile and nonvolatile, removable and non-removable media implemented in any method or technology for storage of information, such as computer readable instructions, data structures, program modules, or other data. Memory 113 may be implemented as a single storage device but may also be implemented across multiple storage devices or sub-systems.

Memory 113 may comprise additional elements, such as a controller, capable of communicating with processing system 112. Examples of storage media include random access memory, read only memory, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software stored on or in memory 113 may comprise computer program instructions, firmware, or some other form of machine-readable processing instructions having processes that when executed by processing system 112 direct utility indication system 100 to operate as described herein.

The software may also include user software applications. The software may be implemented as a single application or as multiple applications. In general, the software may, when loaded into processing system 112 and executed, transform processing system 112 from a general-purpose device into a special-purpose device customized as described herein.

User interface 114 may have input devices such as a keyboard, a mouse, a voice input device, arrow up/down buttons, and/or a touch input device, and comparable input devices. Output devices such as a display, speakers, printer, and other types of output devices may also be included with user interface 114. For example, in FIG. 1, user interface 114 may include a graphical user interface for displaying information and receiving input data. User interface 114 may also be considered to be an integration of utility indication system 100 with software elements, such as operating system and application software.

If included, the graphical user interface can include graphical and text-based user input elements, such as forms, slider bars, text boxes, buttons, radio buttons, check boxes, windows, icons, and pull-down menus, among other input elements, including combinations or variations thereof. Graphical user interface can be presented in a spreadsheet, interactive web page, discrete application, mobile phone app, tablet device app, windowing environment, or other graphical environments.

In an example, utility indication system 100 is a computing device, such as a personal computer, laptop, tablet computing device, mobile smartphone, server, or other computing device which can receive user input.

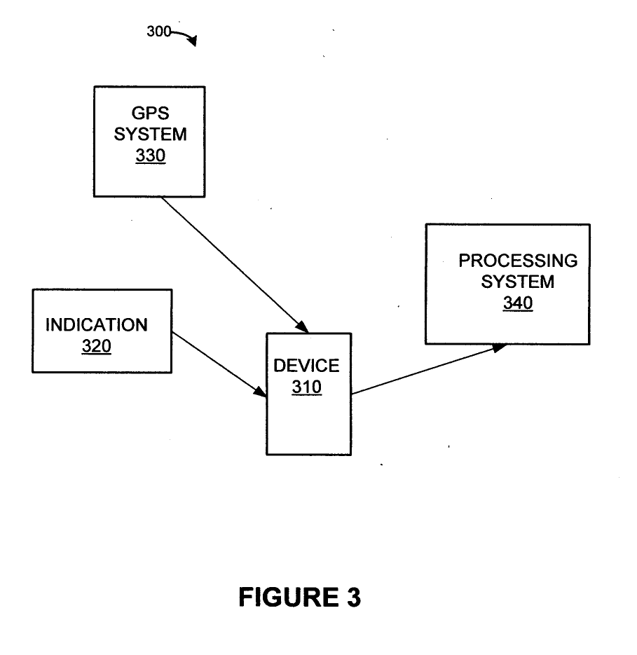

FIG. 3 is a system diagram illustrating utility indication environment 300. Utility indication environment 300 includes a device 310 which receives an indication 320 of a location of a utility. Device 310 may use a GPS 330 and/or the indication 320 to determine coordinates of the location of the utility. The device 310 may save and provide the location information to a processing system 340. As noted above the location information may be transmitted to processing system 340. The information may also be transferred via some other method or system including memory devices, such as SD cards and/or memory sticks, etc.

Processing system 340 may combine the location information and map information. Processing system may also include a database, such that many utility locations may be combined in the database for future use.

Processing system 340 may then transmit the combined location and map information to another device for use. The other device may be another computing system, handheld device, and/or other device. The other device may have an application (app) to use the devices positioning information and the transmitted information to better locate utilities.

With this system, new and existing utilities may be located and very accurate location information may be determined and combined with maps. This will increase safety and save time and money.

FIG. 4 is a flow diagram illustrating a method 400 of operation utility indication system 100, according to an example. The operations of FIG. 4 are referenced herein parenthetically. In FIG. 2, utility indication system 100 receives (410) an indication 121 of location of a utility. The indication may come from a previously located utility done by a utility locator operated by an employee of the utility company (or an independent company contracted to locate for the utility company) which owns a buried utility. The utility indication system may use global positioning system (GPS) coordinates to indicate where the utility is located. The indication of location of the utility 121 may also come from a database of previously located utilities.

Once utility indication system 100 receives an indication of the location of the utility, system 100 may then receive (420) OPS or other information relating to the location of the system 100. The system 100 may then determine utility proximity information (430) based at least in part on the indication of location of the utility and the location information relating to the device 100. Then device 100 may then provide an indication of the utility proximity information (440). This indication may be an audible warning and distance information, among other information.

The utility location information may be used with programs such as computer aided design programs. Furthermore the information may be used with auto-controlled equipment so that the construction or other operations may not unintentionally sever the utility. In addition, the utility location information may be used by mapping companies, such as Google™ or other companies.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of this disclosure. Those skilled in the art will also appreciate that the features described above can be combined in various ways to form multiple embodiments. As a result, the invention is not limited to the specific embodiments described above, but only by the claims and their equivalents.

What is claimed is:

1. A non-transitory computer readable medium having stored thereon program instructions executable by a computing device that, if executed by the computing device, direct the computing device to:
receive an indication of location of a utility;
receive location information of a device;
determine utility proximity information; and
provide an indication of utility proximity information.

2. The non-transitory computer readable medium of claim 1, further comprising instructions which cause the processor to further utilize the indication of the location of the utility.

3. The non-transitory computer readable medium of claim 1, wherein the indication of location of a utility is received from a database.

4. The non-transitory computer readable medium of claim 1, wherein the indication of location of a utility comprises global positioning information.

5. The non-transitory computer readable medium of claim 4, wherein the indication of location of a utility comprises coordinates.

6. The non-transitory computer readable medium of claim 1, further comprising instructions which cause the processor aggregate the indication of location of a utility, and map information.

7. The non-transitory computer readable medium of claim 6, wherein the aggregated information is presented on a personal communication device.

8. The non-transitory computer readable medium of claim 7, wherein the map information comprises electronic information.

9. The non-transitory computer readable medium of claim 1, wherein the location information relating to the utility is received at least in part from a satellite vehicle of a global positioning system.

10. A device comprising:
a user interface capable of receiving an indication of location of a utility;
a processor configured receive location information of the device, and provide an indication of proximity of the utility based at least in part on the indication of the location of the utility, and/or the location information of the device.

11. The device of claim 10, wherein the processor is further configured use the indication of the location of the utility in a grading operation.

12. The device of claim 1, wherein the grading operation is accomplished at least in part with a machine controlled using at least the indication of the location of the utility.

13. The device of claim 10, wherein the indication of the location of the utility information comprises global positioning information.

14. The device of claim 13, wherein the indication of the location of the utility comprises coordinates.

15. The device of claim 10, wherein the device comprises a personal communication device.

16. The device of claim 10, wherein the location information of the device is received at least in part from a satellite vehicle of a global positioning system.

17. A method of determining more accurate utility location information, the method comprising:
receiving an indication of location of a utility by a device;
receiving location information relating to the device; and
grading a location proximate the utility based at least in part using the indication of the location of the utility and the location information relating to the device.

18. The method of claim 17, further comprising transmitting and/or saving the more accurate utility location information.

19. The method of claim 17, wherein the indication of the location of the utility and the location information relating to the device comprise global positioning information.

20. The method of claim 17, wherein the device comprises a personal communication device and the method is accomplished at least in part by an application running on the device.
